(19) United States
(12) Patent Application Publication
(10) Pub. No.: US 2023/0312045 A1
(43) Pub. Date: Oct. 5, 2023

(54) STRUCTURAL MONOCOQUE FOR A MOTORCYCLE

(71) Applicant: SAIETTA GROUP PLC, Upper Heyford, Oxfordshire (GB)

(72) Inventors: Lawrence MARAZZI, Upper Heyford, Oxfordshire (GB); Pablo ROMERO NÚÑEZ, Upper Heyford, Oxfordshire (GB)

(21) Appl. No.: 18/001,298

(22) PCT Filed: Jun. 11, 2021
(86) PCT No.: PCT/GB2021/051466

§ 371 Date: Dec. 9, 2022

(30) Foreign Application Priority Data
Jun. 12, 2020 (GB) 2008985.0

(51) Int. Cl. B62K 11/04; B62J 43/16; B62J 43/28

(52) U.S. Cl. CPC B62K 11/04; B62K 2204/00; B62J 43/28; B62J 43/16

(57) ABSTRACT

The present invention relates to a monocoque frame (100) for a motorcycle, comprising: a structural loop (102) formed of composite material, comprising a plurality of mounts for mounting components of the motorcycle; and at least one structural panel (104, 106) formed of composite material, removably mounted to an open side of the structural loop (102). The or each structural panel (104, 106) comprises at least one elongate formation (110a, 110b) for providing structural rigidity. The invention further relates to a motorcycle, such as an electric motorcycle, incorporating the monocoque frame.

The present invention relates to a structural monocoque for a motorcycle. In particular, the present invention relates to a structural monocoque for an electric, or hybrid electric, motorcycle having energy storage means, such as batteries comprising one or more electrochemical cells.

In vehicles, and in particular motorcycles, there is always a need to increase the structural rigidity of the frame to which the front and rear suspension, and powertrain, is mounted. The weight and overall cost of the frame must also be considered, and as will be appreciated are key factors in the design process.

In addition, there is clearly a desire to transition away from vehicles powered exclusively by hydrocarbon-based fuels and internal combustion engines, and towards vehicles powered by electricity provided from batteries, such as those comprising one or more electrochemical cells, and electric motors. The transition may proceed through so-called hybrid vehicles comprising an additional power source, for providing direct motive power, and/or for charging the on-board batteries. Such additional power sources may be an internal combustion engine, fuel cells, solar cells, or the like.

This transition presents many problems. One such problem is that electrochemical cells used to form batteries have a significantly lower energy density as compare to hydrocarbon based fuels, such as petrol and diesel. This problem is of particular note when designing an electric, or electric hybrid, motorcycle. As will be appreciated, the additional weight and volume of batteries required for such a motorcycle, as compared to a conventional motorcycle, are significant factors which must be considered in the design process. In addition to ensuring that the motorcycle weight and strength is suitable for the use cases, the cost of the motorcycle is also an important consideration.

Motorcycle frame designs which attempt to solve these issues are known, and many attempt to use composite materials to reduce weight, while maintaining the required structural rigidity. EP 2 670 655 B1 discloses one such motorcycle frame. This document discloses the use of a monocoque frame having internal structural bulkheads to provide rigidity and for mounting the batteries. The monocoque frame of EP 2 670 655 B1 has a lid which allows access to the batteries housed within the monocoque. Nevertheless, the present inventors have understood that improvements to the existing motorcycle frames are required.

It is therefore an object of the present invention to provide an improved monocoque frame for a motorcycle, which may reduce weight and cost while at least maintaining or even increasing the structural rigidity of the motorcycle.

According to a first aspect of the present invention, there is provided a monocoque frame for a motorcycle, comprising: a structural loop formed of composite material, comprising a plurality of mounts for mounting components of the motorcycle; and at least one structural panel formed of composite material, removably mounted to an open side of the structural loop. The or each structural panel comprises at least one elongate formation for providing structural rigidity.

Advantageously, providing at least one removable structural panel having elongate formations enables a monocoque frame for a motorcycle to be provided which allows access to, for example, batteries, and/or other components, mounted within the monocoque frame for maintenance and the like. In addition, despite the improved access to the batteries and/or other components, the structural rigidity of the frame can be increased for a given weight of frame, or the structural rigidity can be maintained while reducing the weight of the frame. As will be appreciated, it is also advantageously possible to reduce the cost of the frame by reducing the amount of material used.

Where the motorcycle is an electric motorcycle, the structural loop and the or each structural panel preferably forms a housing for a plurality of batteries for powering the motorcycle.

In the embodiment where the monocoque frame comprises only one removable structural panel, the structural loop preferably comprises an integral structural panel provided on the opposite side of the structural loop to the open side.

In a preferred embodiment, the monocoque frame comprises a first structural panel formed of composite material, removably mounted to a first open side of the structural loop; and a second structural panel formed of composite material, removably mounted to a second open side of the structural loop. Advantageously, providing two removable structural panels yet further improves the access to the batteries and/or other components.

Where appropriate, the following features apply to the embodiments of the invention comprising only one removable structural panel, and also to the embodiments of the invention comprising two removable structural panels.

In a preferred embodiment, each of the first and second structural panels comprise a plurality of elongate formations. The plurality of elongate formations may be substantially parallel to each other. The plurality of parallel elongate formations may extend in a direction from a first side of the structural loop, adjacent a front wheel of the motorcycle, towards a second side, adjacent a rear wheel of the motorcycle. The plurality of elongate formations may thus be substantially horizontal when a motorcycle incorporating the monocoque frame is on level ground.

Preferably, the, or at least one of the, elongate formations of each of the first and second structural panels is integrally formed with the respective structural panel. The, or at least one of the, elongate formations of each of the first and second structural panels is preferably an elongate protrusion forming a rib. The elongate protrusion preferably projects into the housing formed by the structural loop and the first and second structural panels. The profile of each elongate formation is preferably rectangular. The ends of the elongate protrusions may be semi-circular, or square.

In an alternative embodiment, the plurality of elongate formations form a cross. A first arm of said cross may extend in a direction from a mounting for a rear suspension of the motorcycle towards a mounting for a front suspension of the motorcycle.

Each edge of the elongate protrusions preferably comprises a radius. In this way, the stress concentrations around the elongate protrusions may be reduced.

Each of the first and second structural panels may optionally comprise between about 2 and about 15 elongate formations, or optionally between about 5 and about 12, and in one particular embodiment 9 elongate formations. However, as will be appreciated, any suitable number of elongate formations may be provided in each of the structural panels.

Preferably, the or each elongate formation is configured such that each structural panel comprises a peripheral section excluding said formations. In this way, the peripheral section of each structural panel may engage with the structural loop more effectively. It has been found that the frictional joint between the structural panels and the structural loop is an important factor in obtaining a rigid frame for a motorcycle.

The structural loop preferably comprises at least one elongate formation, the or each elongate formation extending around a portion of the circumference of the structural loop. The, or at least one of the, elongate formation of the structural loop is preferably integrally formed with the structural loop. The, or at least one of the, elongate formation of the structural loop is preferably an elongate protrusion forming a rib. The elongate protrusion preferably projects into the housing formed by the structural loop and the first and second structural panels. Advantageously, the or each elongate formation in the structural loop not only improves the structural rigidity of the structural loop, but may also provide the rider of the motorcycle with a position to place the chin portion of their helmet while riding the motorcycle in the tucked, aerodynamic, position.

The, or at least one of the, elongate formations may comprise an elongate structural member. The elongate structural member may be integrated with the structural panel. Alternatively, the elongate structural member may be affixed to the structural panel. The elongate structural member may be bonded to the structural panel, or affixed using fasteners. The elongate structural member may be a hollow tubular member formed of metal, or may be a composite such as a skinned honeycomb. The honeycomb and the skin may be metal, such as aluminium, or an alloy thereof.

The structural loop preferably comprises a flange disposed around the or each open side, wherein the or each structural panel are mounted to respective flanges. The or each flange preferably projects in a direction from the outer surface of the structural loop towards an inner surface of the structural loop.

The structural panels are preferably mounted using a plurality of fastenings. The fastenings may be bolts having washers. Advantageously, the washers are sufficiently large to ensure the loads are distributed over a large area of the composite material. The fasteners are preferably tightened to a torque such that the maximum stress in the vicinity of each fasteners is less than or equal to 40 MPa.

The structural loop and the structural panels are preferably formed of a woven fibre material and resin composite. The woven fibre material is preferably a woven carbon fibre material, preferably 2/2 twill woven carbon fibre material. The 2/2 twill woven carbon fibre may have a basis weight of between about 200 g/m² and about 1000 g/m². The basis weight may be between about 300 g/m² and about 900 g/m², and in one particular embodiment is about 800 g/m².

The structural loop may optionally comprise at least one first section comprising X layers of woven fibre material, and at least one second section comprising Y layers of woven material, where Y is greater than X. Advantageously, providing the structural loop with sections having different numbers of layers enables the weight of the frame to be reduced, while ensuring that the sections of the structural loop which undergo the greatest stress have sufficient strength to resist those stresses.

Y may optionally be between 2 and 15, or between 3 and 10, and in one particular embodiment Y is 5. X may be between 1 and 13, or may optionally be between 2 and 9, and in one particular embodiment X is 3.

As will be appreciated, the basis weight of the composite material used, and the number of layers of that material, may be varied in accordance with the design requirements. For example, a high number of layers of material having a low basis weight may be used, or a low number of layers of material having a high basis weight may be used. Any suitable combination is envisaged by the present disclosure.

The structural loop may optionally comprise two sections comprising Y layers of woven fibre material, the sections being a portion configured to form the top of the motorcycle frame, and a portion configured to form the front of the motorcycle frame.

The structural panels may optionally comprise Z layers of woven material. Z may be equal to, less than, or greater than Y, and/or X.

At least one of the plurality of mounts may be integrated into the composite material forming the structural loop. The integrated mounts are preferably sandwiched between two of the layers of woven fibre material. The integrated mounts may comprise a hollow tubular portion and a flange at a first end of said tubular portion.

Alternatively, the mounts may be bonded to the structural loop using adhesive. The adhesive may be an epoxy resin.

The plurality of mounts preferably include: a first swing arm mount and a second swing arm mount, configured to receive a rear suspension swing arm of a motorcycle; and an alignment member configured to align the first swing arm mount and the second swing arm mount to each other.

The internal surfaces of the structural loop, and the structural panels, preferably comprise electrical insulation. The electrical insulation may be formed from at least one layer of fibreglass material. The electrical insulation may be formed by spraying the internal surfaces, such as with an alkyd resin spray, or the like.

The structural loop may further comprise at least one partition extending from a first side of the structural loop to a second side of the structural loop. The partition is preferably configured to support at least one of the plurality of batteries housed within the housing formed by the structural loop and the structural panels. Advantageously, this enables the bottom section of the structural loop to be formed of less material, while maintaining the structural rigidity to support the batteries. In this way, the weight of the monocoque may be kept to a minimum.

According to a further aspect of the present disclosure, there is provided a monocoque frame fora vehicle or other device, comprising: a structural loop formed of composite material, comprising a plurality of mounts for mounting components of the vehicle or other device; and at least one structural panel formed of composite material, removably mounted to a first open side of the structural loop. The or each structural panel comprises at least one elongate formation for providing structural rigidity.

According to a further aspect of the present disclosure, there is provided a monocoque frame a vehicle, comprising: a structural loop formed of composite material, comprising a plurality of mounts for mounting components of the vehicle. At least one of the plurality of mounts is integrated into the composite material forming the structural loop.

The above described optional features of the monocoque frame according to the first aspect of the present invention, where applicable, may also be incorporated into the monocoque frame according to a further aspect of the present disclosure.

According to a further aspect of the present invention, there is provided a motorcycle comprising: a monocoque frame as described above; a front wheel and front suspension, the front suspension mounted to the structural loop; and a rear wheel and rear suspension, the rear suspension mounted to the structural loop.

Advantageously, providing a motorcycle having such a monocoque enables a lightweight, structurally rigid, motorcycle to be provided which has batteries that are easily accessible for maintenance and the like.

The motorcycle may further comprise an electric motor having transmission configured to provide motive force to the rear wheel, the motor being mounted to the structural loop; and a plurality of batteries, for powering the motor, mounted within the housing formed by the structural loop and first and second structural panels. In this embodiment, the motorcycle is an electric, or hybrid, electric motorcycle.

The electric motorcycle may further comprise a secondary power source. In this way a hybrid electric motorcycle may be provided. The secondary power source may be configured to provide motive force to the rear wheel. The secondary power source may be configured to charge the batteries. The secondary power source is preferably mounted within the housing formed by the structural loop and first and second structural panels. The secondary power source may be one of: an internal combustion engine; a fuel cell; and photovoltaic cells.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

The invention will be further described, by way of example only, with reference to the accompanying drawings in which:

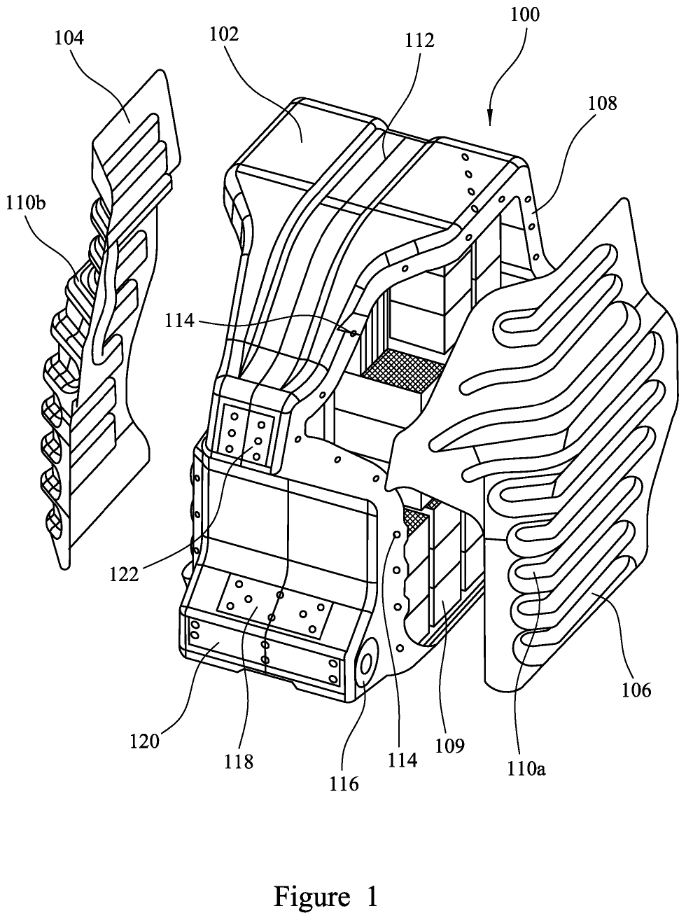

FIG. 1 shows an exploded perspective view of a monocoque frame according to the present invention;

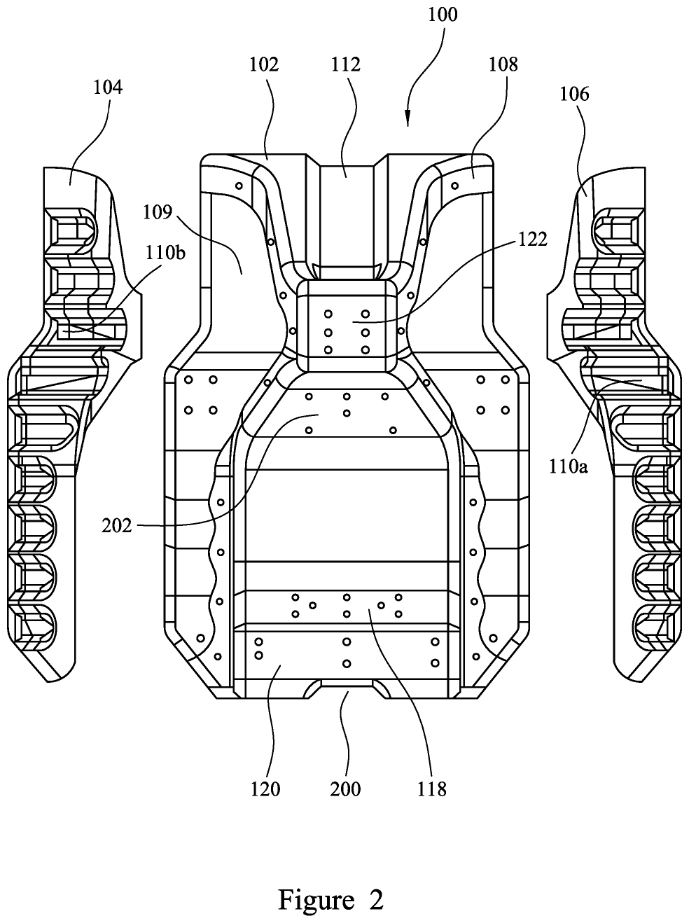

FIG. 2 shows an exploded end view of the monocoque frame shown in FIG. 1;

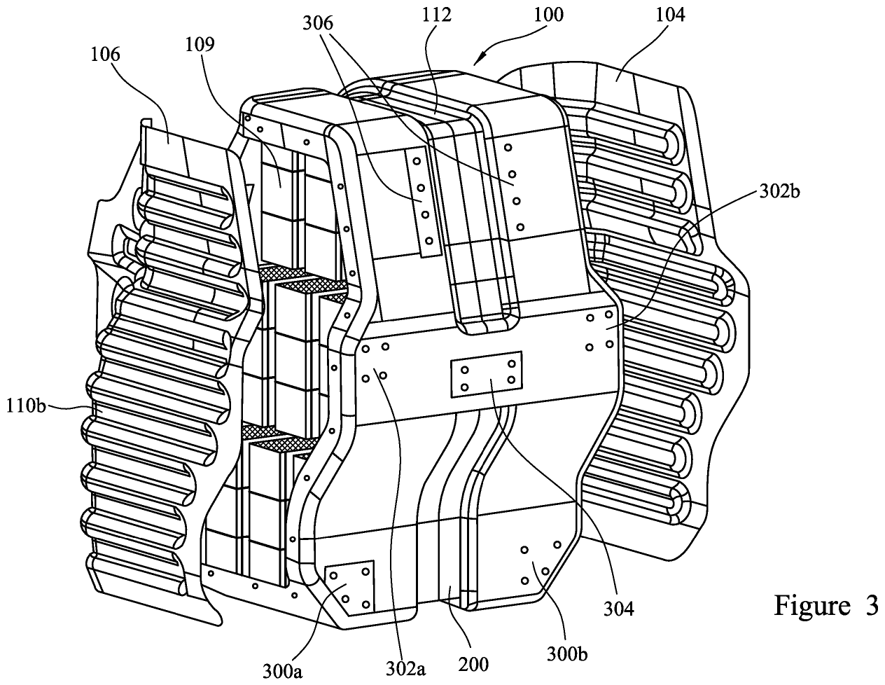

FIG. 3 shows an alternative exploded perspective view of the monocoque frame shown in FIG. 1;

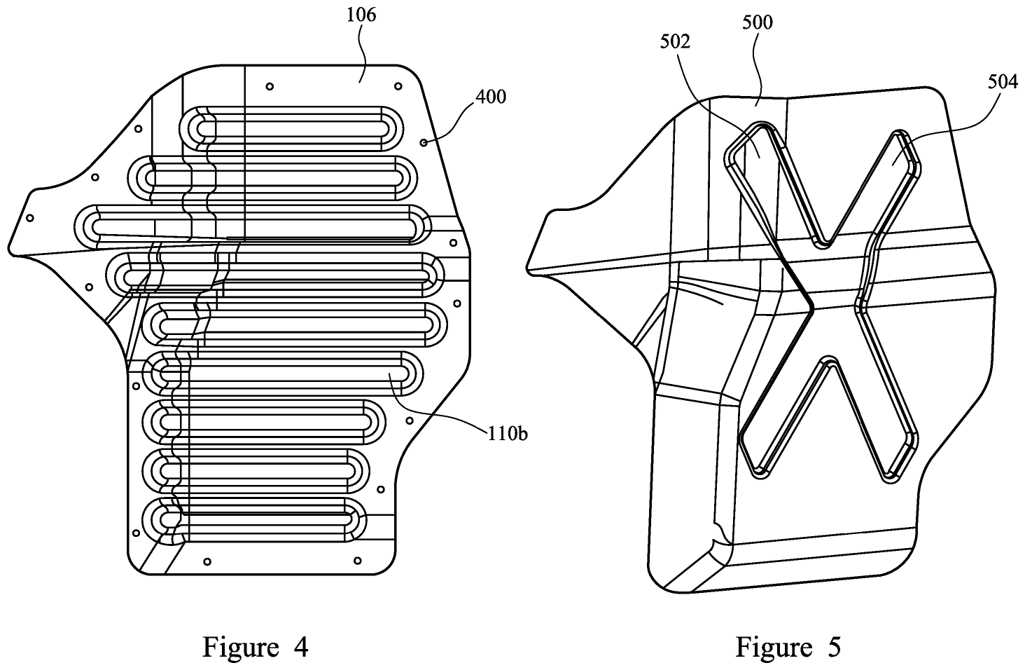

FIG. 4 shows a side view of a structural panel of a monocoque frame according to the present invention;

FIG. 5 shows a side view of an alternative structural panel of a monocoque according to the present invention;

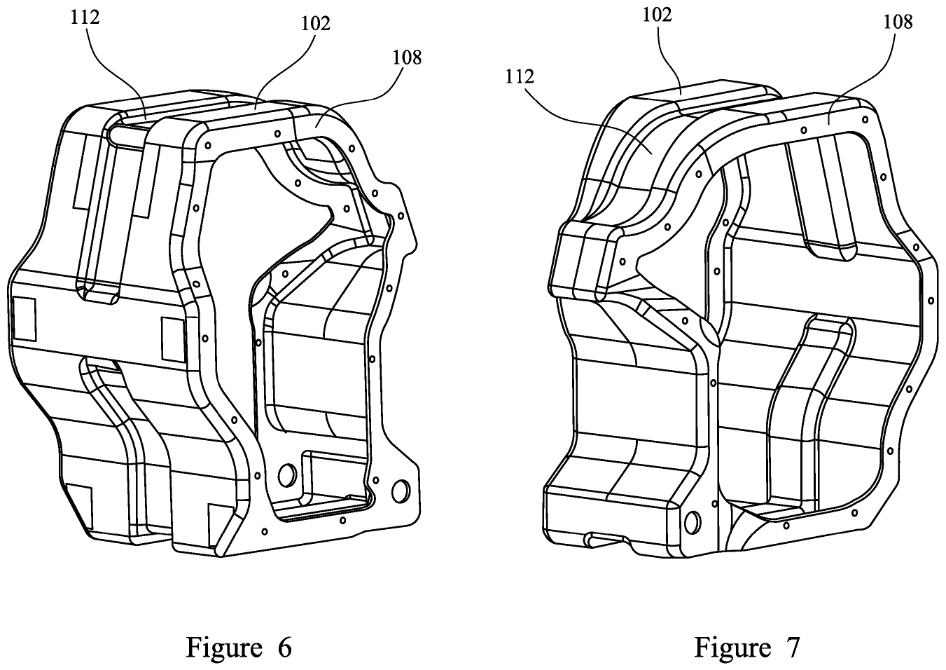

FIG. 6 shows a perspective view of a structural loop of a monocoque frame according to the present invention;

FIG. 7 shows an alternative perspective view of the structural loop shown in FIG. 6;

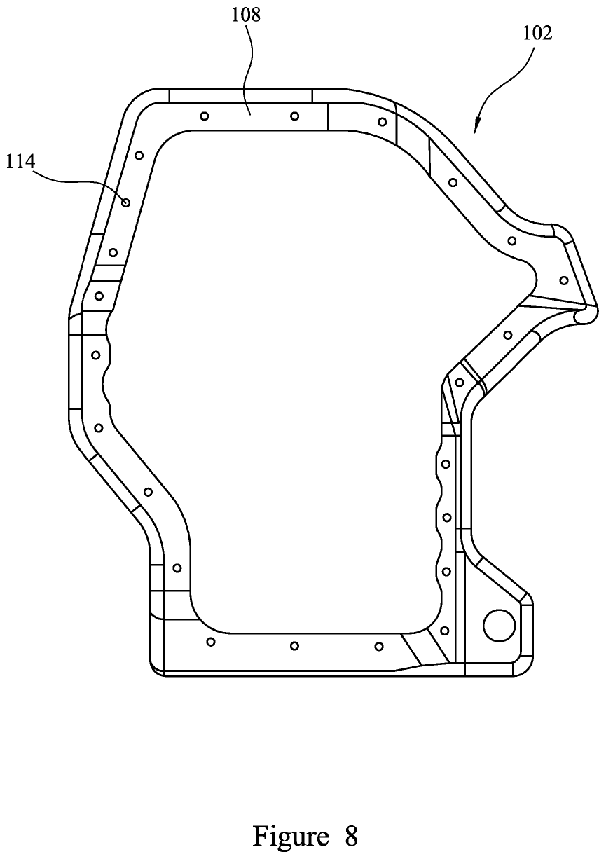

FIG. 8 shows a side view of the structural loop shown in FIGS. 6 and 7;

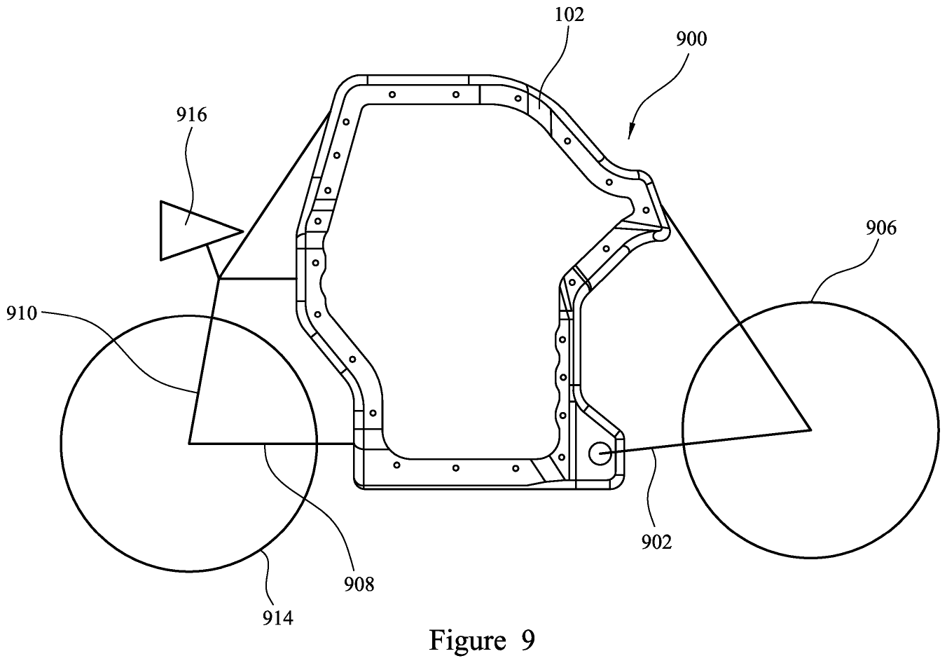

FIG. 9 shows a perspective view of an electric motorcycle incorporating a monocoque frame according to the present invention;

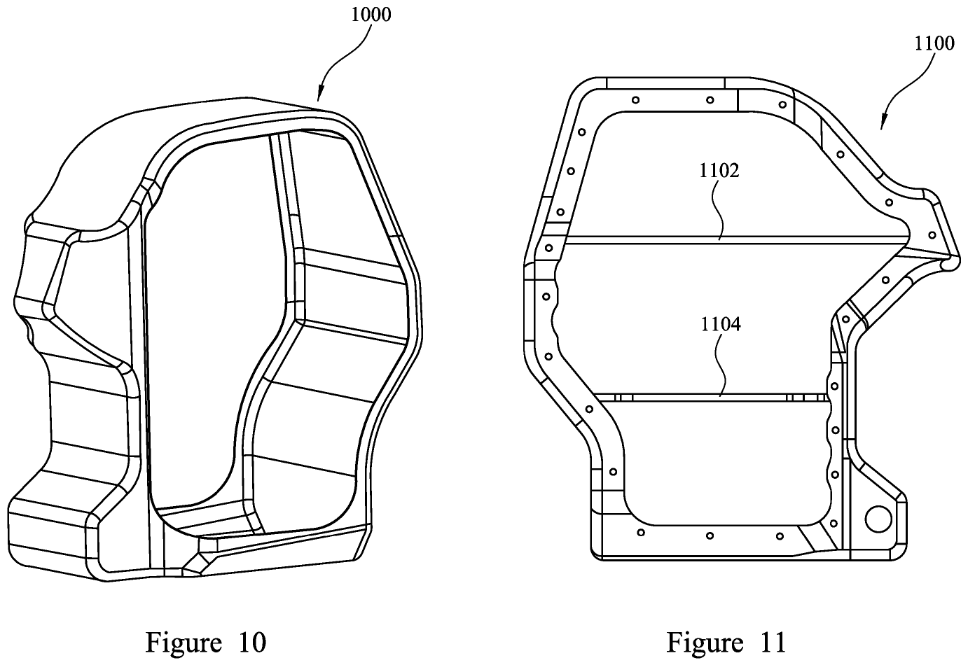

FIG. 10 shows a perspective view of an alternative structural loop according to the present invention; and

FIG. 11 shows a cross-sectional perspective view of a structural loop according to the present invention having internal partitions.

Referring to the attached figures, where like reference numerals refer to like features, the present disclosure relates to a composite monocoque frame 100 for an electric motorcycle. The monocoque frame 100 comprises a main structural loop 102 and two removable structural side panels 104 and 106. The main structural loop 102 and the structural side panels 104 and 106 are formed of a composite material. In the example described with reference to the attached figures, the material used is a carbon fibre resin composite, where the carbon fibre is a woven material with a twill 2/2 weave and a basis weight of about 800 g/m². The number of layers of woven carbon fibre material varies around the structural loop 102. In this example, the top and front portions of the structural loop comprise 5 layers, or plies, of material, and the bottom and rear portions comprise 3 layers. The structural side panels 104 and 106 comprise 5 layers.

The structural side panels 104 and 106 are removably attached around the periphery to the structural loop 102 by fasteners (not shown) such as bolts. The bolts are provided with washers to distribute the load. To facilitate the attachment, and to ensure that a peripheral band of the structural side panels 104 and 106 engages with the structural loop 102, the structural loop has a flange 108 on each open side. The structural loop 102 further comprises various mounts for attaching the components of the electric motorcycle; the mounts are described below in further detail. The structural loop 102 and structural side panels 104 and 106 form a housing for batteries 109 for powering the motorcycle.

Each structural side panel 104 and 106 comprises a respective plurality of elongate formations 110a and 110b, in the form of protrusions in the surface, for increasing the structural rigidity of the monocoque frame. In the example shown in FIGS. 1, 2, 3, and 4, the elongate formations are substantially parallel to each other, and arranged to be substantially horizontal when the motorcycle incorporating the monocoque frame is on horizontal ground. As can be seen, the example comprises nine elongate formations, but as will be appreciated the number of elongate protrusions may be varied in accordance with the design requirements of the particular motorcycle. The main design requirement of the present example was a deflection at the front suspension damper mount of no more than 2 mm under a vertical load equivalent to 3.5 g (i.e. 3.5 times the weight of the motorcycle and rider).

To further increase the structural rigidity of the monocoque frame, the structural loop 102 is provided with two elongate formations 112 and 200 (shown in FIGS. 2 and 3). The elongate formations 112 and 200, in the form of elongate protrusions protruding into the housing formed by the structural loop and the structural side panels, extend around the circumference of the structural loop 102. The elongate formations 112 and 200 are provided on the top and on the bottom of the structural loop. In use, the rider of the motorcycle s able to place their helmet within the top protrusion for comfort and to improve the aerodynamic riding position.

As can be seen, the shape of the monocoque frame is sufficiently ergonomic to accommodate rider without significant modification of the natural riding position.

As described above, the flanges 108 around the periphery of the open sides of the structural loop 102 enable the structural side panels to be removably attached, or mounted, to the structural loop to, in effect, provide a box-like monocoque frame. As can be seen, for example in FIGS. 1, 2, 3, 6 and 7, the flanges extend from the outer surface of the structural loop 102 towards the inner surface. In this way, in of themselves they will provide additional structural rigidity. The flanges 108 are provided with a plurality of mounts 114 for receiving fasteners which attach the structural. The mounts are substantially evenly spaced apart around the flange 108.

Further structural mounts are provided within the structural loop 102 for mounting the various components of the motorcycle. The mounts may either be affixed using adhesive, such as epoxy resin, or directly integrated into the composite material during manufacture of the structural loop. That is to say they are, in effect, overmoulded within the layers of woven material before curing.

One such mount 116, provided as a pair disposed either side of the structural loop 102 is configured to receive the swing arm of a rear suspension of the motorcycle. The mounts 116 are aligned with each other using a tubular element (not shown) provided within the housing. During manufacture, the tubular element is inserted within the housing and adjacent holes drilled into the structural loop. A first mount 116 is inserted into the hole drilled into the structural loop 102, and a portion of the mount inserts into the tubular element. The process is repeated for the second mount 116 and then the mounts and tubular element are bonded into position. The mounts 116 and tubular element are configured such that there is a close fit between the outer surface of the mounts and the inner surface of the tubular element.

Further mounts will now be described. The rear suspension damper and spring mount 202 is a substantially flat plate bonded to the structural loop 102. The mount 202 comprises a plurality of tapped holes for receiving fasteners to attach the damper and spring. The motor and drive train mounts 118 and 120 are also substantially flat plates bonded to the structural loop 102, and also comprise a plurality of tapped holes. The seat mount 122 is also a substantially flat plate bonded to the structural loop 102.

Referring now to FIG. 3, the front of the monocoque frame 100 configured to receive the front suspension is shown. In this example, the front suspension is of the double wishbone type. As such a set of lower wishbone mounts 300a and 300b are provided, and a set of upper wishbone mounts 302a and 302b are provided. Again, the mounts are formed of substantially flat plates bonded to the structural loop 102. Further mounts 304, 306 are provided for mounting the front suspension spring and damper, and for mounting the handlebar steering components.

All of the mounts are preferably formed of metal, such as steel, stainless steel, aluminium, or titanium.

The structural side panels will now be described in further detail with reference to FIGS. 4 and 5. FIG. 4 shows a version of the structural side panel 106 having elongate protrusions 110b. As can be seen, this version of the structural side panel comprises six elongate protrusions 110b. The protrusions are substantially rectangular in shape, with semi-circular ends. The edges of the protrusions, where they meet the main panel, are provided with a radius o reduce the stress concentrations. The lengths of the protrusions are varied such that they are excluded from a peripheral portion of the side panel which is configured to engage with the flanges 108. The through holes 400 are disposed around the periphery, and are configured to receive the fasteners. Each fasteners is provided with a washer to distribute the load, and are tightened to a torque such that the local stress does not exceed 40 MPa.

FIG. 5 shows an alternative structural side panel 500. As can be seen, the elongate protrusions 502 and 504 are in the form of a cross. The elongate protrusion 504 extends from a location adjacent the rear suspension swing arm mount towards the front suspension spring and damper mount.

FIG. 9 shows a schematic diagram of a motorcycle 900 comprising the monocoque frame 100 as described above. As described above, the front suspension of the motorcycle comprises a lower wishbone 902 and an upper wishbone 904. A spring and damper is mounted to the lower wishbone 902 at a first end, and to the structural loop 102 at a second end. A front wheel 906 is mounted to the forks.

The rear suspension comprises a swing arm 908 and a rear suspension spring and damper 910 mounted to the swing arm at a first end and to the structural loop 102 at a second end. An electric motor 912 is mounted to the structural loop, and a drivetrain couples the motor to the rear wheel 914. The drivetrain may comprise a gearbox.

Finally, a seat member 916 is provided, which is mounted to the structural loop 102.

A set of batteries is provided within the housing formed by the structural loop 102 and the structural side panels 104 and 106. In this example, 27 batteries are provided, which each comprise a plurality of electrochemical cells for powering the motor to drive the motorcycle. In this example, the 27 batteries provides approximately 30 kWh of energy. As will be appreciated, more or fewer batteries may be provided within the housing depending on the requirements of the motorcycle.

FIGS. 10 and 11 show alternative structural loops. In FIG. 10, the structural loop 1000 is substantially the same as structural loop 102, but does not comprise any elongate protrusions. FIG. 11 shows an example of a structural loop 1100 where partitions 1102 and 1104 are provided within the housing for supporting the batteries. Partitions 1102 and 1104 may be required where the whole volume of the housing comprises batteries in order to support the weight of the batteries. Without such partitions, the batteries would be supported only by the bottom of the structural loop which would require that section to be strengthened, and thereby increasing the weight and cost.

1-25. (canceled)

26. A monocoque frame for a motorcycle, comprising:
a structural loop formed of composite material, comprising a plurality of mounts for mounting components of the motorcycle; and
at least one structural panel formed of composite material, removably mounted to an open side of the structural loop;
wherein, the or each structural panel comprises at least one elongate formation for providing structural rigidity.

27. A monocoque frame according to claim 26, comprising: a first structural panel formed of composite material, removably mounted to a first open side of the structural loop; and a second structural panel formed of composite material, removably mounted to a second open side of the structural loop.

28. A monocoque frame according to claim 26, wherein the or the structural panel comprises a plurality of elongate formations.

29. A monocoque frame according to claim 28, wherein the, or at least one of the, elongate formations of the or each structural panel is integrally formed with the respective structural panel.

30. A monocoque frame according to claim 28, wherein the, or at least one of the, elongate formations of the or each structural panel is an elongate protrusion forming a rib and wherein preferably the elongate protrusion projects into the monocoque frame formed by the structural loop and the or each structural panel.

31. A monocoque frame according to claim 28, wherein the plurality of elongate formations are substantially parallel to each other and wherein preferably extend in a direction from a first side of the structural loop, adjacent a front wheel of the motorcycle, towards a second side, adjacent a rea wheel of the motorcycle.

32. A monocoque frame according to claim 28, wherein the plurality of elongate formations form a cross and wherein preferably a first arm of said cross extends in a direction from a mounting for a rear suspension of the motorcycle towards a mounting for a front suspension of the motorcycle.

33. A monocoque frame according to claim 28, wherein the or each elongate formation is configured such that the or each structural panel comprises a peripheral section excluding said formations.

34. A monocoque frame according to claim 26, wherein the structural loop comprises at least one elongate formation, the or each elongate formation extending around a portion of the circumference of the structural loop.

35. A monocoque frame according to claim 34, wherein the, or at least one of the, elongate formation of the structural loop is integrally formed with the structural loop.

36. A monocoque frame according to claim 34, wherein the, or at least one of the, elongate formation of the structural loop is an elongate protrusion forming a rib.

37. A monocoque frame according to claim 34, wherein the, or at least one of the, elongate formations comprises an elongate structural member.

38. A monocoque frame according to claim 26, wherein the or each open side of the structural loop comprises a flange disposed around the or each open side, wherein the or each structural panel is, or are, are mounted to the or each flange.

39. A monocoque frame according to claim 26, wherein the structural loop and the or each structural panel are formed of a woven fibre material and resin composite.

40. A monocoque frame according to claim 26, wherein the structural loop and the or each structural panel forms a housing for a plurality of batteries for powering the motorcycle.

41. A motorcycle comprising:
a monocoque frame according to claim 26;
a front wheel and front suspension, the front suspension mounted to the structural loop;
a rear wheel and rear suspension, the rear suspension mounted to the structural loop.

42. A motorcycle according to claim 41, further comprising: an electric motor having transmission configured to provide motive force to the rear wheel, the motor being mounted to the structural loop; and a plurality of batteries, for powering the motor, mounted within the housing formed by the structural loop and the or each structural panel.

43. A motorcycle according to claim 42, further comprising a secondary power source, wherein the secondary power source is configured to provide motive force to the rear wheel and/or charge the batteries.

44. A motorcycle according to claim 43, wherein the secondary power source is mounted within a housing formed by the structural loop and the or each structural panel.

45. A monocoque frame a vehicle, comprising:
a structural loop formed of composite material, comprising a plurality of mounts for mounting components of the vehicle;
wherein, at least one of the plurality of mounts is integrated into the composite material forming the structural loop.
